(19) United States
(12) Patent Application Publication
(10) Pub. No.: US 2025/0182134 A1
(43) Pub. Date: Jun. 5, 2025

(54) VIRTUAL AI REPRESENTATIVE

(71) Applicant: WISHPOND TECHNOLOGIES LTD., Vancouver (CA)

(72) Inventors: Nasim Arianpoo, North Vancouver (CA); Ali Tajskandar, North Vancouver (CA); Alabin Jordan Carel Gutierrez Keever, North Vancouver (CA)

(21) Appl. No.: 18/527,241

(22) Filed: Dec. 2, 2023

(51) Int. Cl. G06Q 30/015; G06N 5/022

(52) U.S. Cl. CPC G06Q 30/015; G06N 5/022

(57) ABSTRACT

The present invention provides a method and system for communication between an artificially intelligent virtual representative and a user via both conversation and visual interaction. The invention encompasses several key components and processes that enable efficient and context-aware interactions between the virtual representative and the user. The system of the present invention includes a controller unit, large Language model (LLM) interactive-conversation unit, state manager unit, user input unit, action controller unit, vocalizer unit, knowledge base unit, user conversation encoder unit, and interrupt and user monitoring unit.

### BACKGROUND

The present invention relates artificial intelligent (AI) assistants that can be adapted to perform a directed function, and more specifically, to conversationally interact according to the directed function.

### SUMMARY

According to one embodiment of the invention, there is provided a method for facilitating a directed conversation according a criteria between an artificially-intelligent (AI) agent and an audience. A state machine is received by an AI system containing the AI agent. The state machine controls the directed conversation. A knowledge base for the directed conversation is ingested by the system. An interactive presentation for the directed conversation as indicated by the state machine is provided by the AI agent.

According to one embodiment of the invention, there is provided an information handling system that implements the steps of the method for facilitating a directed conversation according to a criteria between an artificially-intelligent (AI) agent and an audience.

According to one embodiment of the invention, there is provided a computer program product running program instructions executable on a processing circuit to cause the processing circuit to perform the steps facilitating a directed conversation according to a criteria between an artificially-intelligent (AI) agent and an audience.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The accompanying drawings, which are included to provide a further understanding of the inventive concepts and are incorporated in and constitute a part of this specification, illustrate exemplary embodiments of the inventive concepts, and, together with the description, serve to explain the principles of the inventive concepts.

FIG. 1 illustrates virtual AI representative core architecture.

FIG. 2 illustrates the process flow for virtual AI representative core operative steps.

FIG. 3 illustrates the virtual AI representative architecture including user dashboard, data storage and virtual AI representative fleet manager and core.

FIG. 4 illustrates an exemplary website that employs a virtual AI representative as a sales agent to present the product to interested participants.

FIG. 5 illustrates a participant requesting for initiating a virtual AI presentation session.

FIG. 6 illustrates a participant joining a meeting session after requesting one.

FIG. 7 illustrates a virtual AI representative starting a meeting session.

FIG. 8 illustrates the user dashboard for a product owner to define the specifications of the virtual AI representative.

FIG. 9 illustrates an exemplary hardware architecture required to implement the present invention.

### DETAILED DESCRIPTION OF THE INVENTION

In the following description, for the purposes of explanation, numerous specific details are set forth to provide a thorough understanding of various exemplary embodiments. It is apparent, however, that various exemplary embodiments may be practiced without these specific details or with one or more equivalent embodiments.

In the accompanying figures, the size and relative sizes of elements may be exaggerated for clarity and descriptive purposes.

The terminology used herein is for the purpose of describing particular embodiments and is not intended to be limiting. As used herein, the singular forms,
“a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Implementing a virtual AI representative may face a range of technical challenges that require sophisticated solutions. One important challenge is that standard natural language processing (NLP) models may not be optimized for long, purposeful, real-time, interactive dialogues and might produce responses that are not contextually accurate or coherent with the flow and purpose of the conversation. Another challenge is maintaining a seamless transition between the conversation and the interactive visual presentation, especially when the interactive presentation is conditional on the dialogue flow. Multiple threads are required to monitor various aspects of the conversation, such as user engagement, presence, or intent. Harmonizing these threads to produce a coherent interaction that follows the flow of the conversation is not straightforward. Another complexity is the response rate; to maintain a natural conversation, the system needs to generate responses within a fraction of a second.

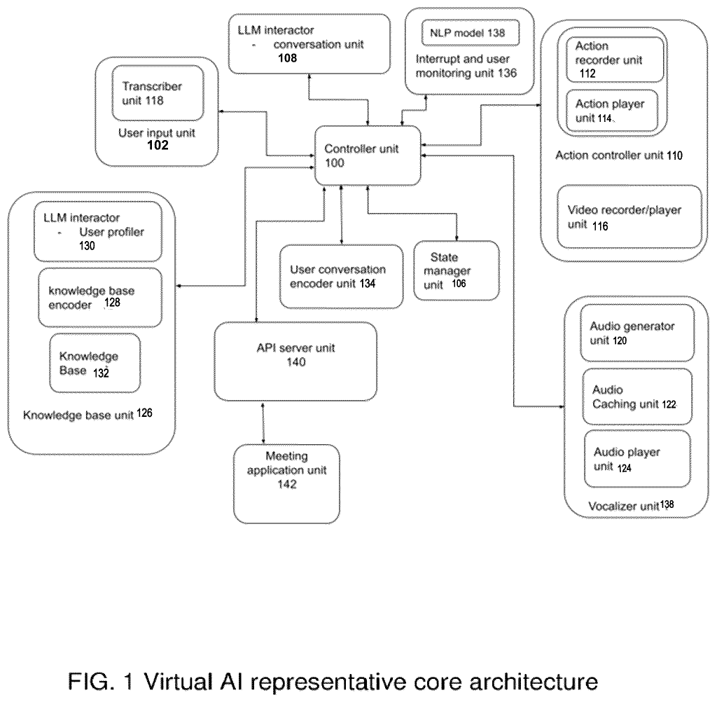

FIG. 1 shows embodiments of the present invention that includes a system and method for an artificially intelligent virtual representative. Elements shown in FIG. 1 are in the form of software. As shown in FIG. 1, the system of the present invention includes the following components:

Controller unit 100 serves as the central processing and orchestration unit in the system. It is the brain behind the operations, ensuring synchronization between different threads and processes. Through a series of event queues, controller unit 100 communicates with various components, responding to and processing events such as user interactions, system updates, and audio inputs. An event queue is a data structure that operates based on the First-In-First-Out (FIFO) principle. The event queue is used to store and manage events or messages that need to be processed. In multithreaded applications such as the present invention, an event queue helps in achieving thread-safe communication between threads.

User input unit 102 is responsible for receiving and processing user voice inputs that come from the meeting application or medium. Transcriber unit 118 resides within user input unit 116. The primary role of transcriber unit 104 is to convert the captured audio data into textual format, essentially “transcribing” spoken words into readable text. Leveraging available advanced speech recognition algorithms, transcriber unit 104 analyzes the audio data. Controller unit 100 messages user input unit 116 at the beginning of the conversation to mark the start of the conversation. State manager unit 106 functions as a dynamic state machine, meticulously tracking and guiding the flow of conversation. The state manager utilizes a range of predefined states to facilitate a structured yet adaptable interaction, catering to a variety of conversational objectives. Each state within this system is defined by unique attributes including a unique identifier, directives on how to respond in each state, optional associated visual content, instructions for the next course of action (transiting to the next state and the conditions for the transit), and if the state is a “wait for response” state for user to provide a response or a “move forward” state that does not wait for the user's input. When a message is received and transcribed by transcriber, transcriber assigns a unique number to it, so the message looks like this {identifier: 2345, message: “how can your product help us?”}

this identifier is used throughout the life cycle of the message, for handling interruption or speeding up the response process.

State manager unit 106 includes two groups of states: user-defined states and system-defined states. System-defined states include “audio connection,” “first state,” “hold,” “interrupt,” and “tangent.” Any other states defined by the user to customize the virtual AI representative for their specific use and to ensure a fluid and intuitive interaction are called user-defined states. Controller unit 100 waits in “audio connection” state until it receives a message form the user at the beginning of the meeting to transit to the “first state.” All user-defined states can transit to the “interrupt” state if the user interrupts the virtual AI representative while presenting; reverting back post-interruption. Queries deviating from the meeting's flow trigger a transition to the “tangent” state, allowing the virtual AI representative to address off-topic inquiries. A user request for a pause shifts the state to “hold.” Each state associates with corresponding visual content on the meeting platform, which pauses when the state transitions and resumes when back in that state again. Transitions between states are guided by conditions that act as triggers, dictating the requirements for movement and identifying the destination state. LLM interactor-conversation unit 108 decides if the transitions conditions are met and determines the state of conversation in each conversation cycle, the conversation cycle consists of a back and forth between the participant and the virtual AI representative.

State manager unit 106 can be adjusted to act as a persona with different set of states. For instance, the virtual AI representative presented in this patent can emulate a virtual AI sales agent when provided with suitable set of states and a product knowledgebase to provide contextual information for knowledgebase unit 126. States dictates how the agent navigates the presentation while demonstrating the product and the knowledgebase provides the agent with prior information about the product. The states for this specific example are included in Table 1. Each state has a name, instruction, transition condition, the next state, and the action the agent has to take after delivering the instruction.

TABLE 1
States for the virtual AI representative to emulate a virtual sales agent

| | | Transition | Next | |
|---|---|---|---|---|
| State name | instruction | goal | state | Action |
| Audio | Ask if they can hear you. Wait | [ALWAYS] | First | wait |
| connection | until you hear their answer. | | state | |
| First state | Welcome them and ask | [ALWAYS] | Agenda | wait |
| | something about the weather or | | | |
| | any suitable small talk. | | | |
| Agenda | Outline the agenda for the | [ALWAYS] | Product | wait |
| | meeting; tell how you will | | | |
| | demonstrate how the product | | | |
| | work and can help with their | | | |
| | business. mention that the first | | | |
| | 10 minutes you'll try to | | | |
| | understand the business, then | | | |
| | let them know that you are | | | |
| | going to share your screen | | | |
| Product | Show them how the product | [ALWAYS] | Final | wait |
| | work via screen share and how | | | |
| | it can help their requirements | | | |
| Tangent | Answer any question they | [ALWAYS] | Previous | wait |
| | might have and redirect the | | state | |
| | conversation back to the main | | | |
| | flow. | | | |
| Hold | Check if they are ready to | [ALWAYS] | Previous | wait |
| | continue | | state | |
| Final | Thank them for their time and | [ALWAYS] | | wait |
| | let them know what are the | | | |
| | next steps. | | | |

The user-defined states for this specific example are Agenda, Product, and Final. User-defined states provided in Table 1 can be more than the ones presented here to refine the conversation and to provide more instruction to the AI sales agent. System-defined states are hold, tangent, interruption, audio connection, and first state. At the beginning of the conversation, the AI agent is in state audio-connection. When the AI agent receives a participant's voice, the AI agent transits to the first-state in which it welcomes the participant. The agent transits to the agenda state in which it outlines the agenda for the meeting. When there is a message from the participants, controller unit 100 sends the message to LLM interactor-conversation unit 108 and LLM interactor-conversation unit 108 answers the message and determines the state in which the AI agent resides.

Arranging the set of states as in Table 2 can tailor the virtual AI representative to emulate an instructor. A course curriculum and related information on the topic of interest is provided to the virtual AI representative via knowledgebase unit 126. User-defined states provided in Table 2 can be more than the ones presented here to refine the conversation and to provide more instruction to the virtual AI instructor.

TABLE 2
States for the virtual AI representative to emulate a virtual instructor

| | | Transition | Next | |
|---|---|---|---|---|
| State name | instruction | goal | state | Action |
| Audio | Ask if they can hear you. Wait | [ALWAYS] | First | wait |
| connection | until you hear their answer. | | state | |
| First state | Welcome them and ask | [ALWAYS] | Agenda | wait |
| | something about the weather or | | | |
| | any suitable small talk. | | | |
| Agenda | Outline the agenda for the | [ALWAYS] | Subject | wait |
| | class for that specific session; | | | |
| | then let them know that you are | | | |
| | going to share your screen | | | |
| Subject | Start with some background on | [ALWAYS] | Final | wait |
| | the topic, and then the main | | | |
| | concept. Check with them | | | |
| | during the presentation to make | | | |
| | sure they are following the | | | |
| | conversation. | | | |
| Tangent | Answer any question they | [ALWAYS] | Previous | wait |
| | might have and redirect the | | state | |
| | conversation back to the main | | | |
| | flow. | | | |
| Hold | Check if they are ready to | [ALWAYS] | Previous | wait |
| | continue | | state | |
| Final | thank them for their time and | [ALWAYS] | | wait |
| | let them know what are the | | | |
| | next steps. | | | |

Arranging the set of states as in Table 3 can tailor the virtual AI representative to emulate a healthcare provider. Related medical knowledge on the topic of specialty is provided to the virtual AI representative via knowledgebase unit 126. User-defined states provided in Table 3 can be more than the ones presented here to refine the conversation and to provide more instruction to the virtual AI healthcare provider.

TABLE 3
States for the virtual AI representative to emulate a virtual healthcare provider

| | | Transition | Next | |
|---|---|---|---|---|
| State name | instruction | goal | state | Action |
| Audio | Ask if they can hear you. Wait | [ALWAYS] | First | wait |
| connection | until you hear their answer. | | state | |
| First state | Welcome them and ask how they | [ALWAYS] | Agenda | wait |
| | are doing and how you can help | | | |
| Agenda | Outline the process for them | [ALWAYS] | Subject | wait |
| | and mention you share the screen | | | |
| Discovery | Start asking about the issue | [ALWAYS] | Final | wait |
| | that prompt them to seek help. | | | |
| Tangent | Answer any question they | [ALWAYS] | Previous | wait |
| | might have and redirect the | | state | |
| | conversation back to the main | | | |
| | flow. | | | |
| Hold | Check if they are ready to | [ALWAYS] | Previous | wait |
| | continue | | state | |
| Final | thank them for their time and | [ALWAYS] | | wait |
| | let them know what are the | | | |
| | next steps. | | | |

The set of states in Table 4 can be used for the virtual AI representative to emulate a customer service representative. User-defined states provided in Table 4 can be more than the ones presented here to refine the conversation.

TABLE 4
States for the virtual AI representative to emulate
a virtual customer service representative

| | | Transition | Next | |
|---|---|---|---|---|
| State name | instruction | goal | state | Action |
| Audio | Ask if they can hear you. Wait | [ALWAYS] | First | wait |
| connection | until you hear their answer. | | state | |
| First state | Welcome them and ask how | [ALWAYS] | Discovery | wait |
| | you can help them with the | | | |
| | product or service in question. | | | |
| Discovery | Answer any question regarding | [ALWAYS] | Final | wait |
| | the product. | | | |
| Tangent | Answer any question they | [ALWAYS] | Previous | wait |
| | might have and redirect the | | state | |
| | conversation back to the main | | | |
| | flow. | | | |
| Hold | Check if they are ready to | [ALWAYS] | Previous | wait |
| | continue | | state | |
| Final | thank them for their time and | [ALWAYS] | | wait |
| | let them know what are the | | | |
| | next steps. | | | |

The set of states in Table 5 can be used for the virtual AI representative to emulate a virtual advisory service provider (i.e. a financial service advisor). User-defined states provided in Table 5 can be more than the ones presented here to refine the conversation.

TABLE 5
States for the virtual representative to emulate a virtual advisory service provider

| | | Transition | Next | |
|---|---|---|---|---|
| State name | instruction | goal | state | Action |
| Audio | Ask if they can hear you. Wait | [ALWAYS] | First | wait |
| connection | until you hear their answer. | | state | |
| First state | Welcome them and ask how | [ALWAYS] | Discovery | wait |
| | you can help them with them | | | |
| Discovery | Answer any question regarding | [ALWAYS] | Final | wait |
| | the product/service. Provide | | | |
| | Personalized suggestions on | | | |
| | the service/product to their | | | |
| | specific need. | | | |
| Tangent | Answer any question they | [ALWAYS] | Previous | wait |
| | might have and redirect the | | state | |
| | conversation back to the main | | | |
| | flow. | | | |
| Hold | Check if they are ready to | [ALWAYS] | Previous | wait |
| | continue | | state | |
| Final | thank them for their time and | [ALWAYS] | | wait |
| | let them know what are the | | | |
| | next steps. | | | |

The set of states in Table 6 can be used for the virtual AI representative to emulate a virtual recruiter. User-defined states provided in Table 6 can be more than the ones presented here to refine the conversation.

TABLE 6
States for the virtual AI representative to emulate a virtual recruiter

| | | Transition | Next | |
|---|---|---|---|---|
| State name | instruction | goal | state | Action |
| Audio | Ask if they can hear you. Wait | [ALWAYS] | First | wait |
| connection | until you hear their answer. | | state | |
| First state | Welcome them and thank them | [ALWAYS] | Discovery | wait |
| | to join the presentation. Explain | | | |
| | the position and requirements | | | |
| | for the position. | | | |
| Discovery | Ask about their background, | [ALWAYS] | Final | wait |
| | and experience. | | | |
| Tangent | Answer any question they | [ALWAYS] | Previous | wait |
| | might have and redirect the | | state | |
| | conversation back to the main | | | |
| | flow. | | | |
| Hold | Check if they are ready to | [ALWAYS] | Previous | wait |
| | continue | | state | |
| Final | thank them for their time and | [ALWAYS] | | wait |
| | let them know what are the | | | |
| | next steps. | | | |

The current state of the conversation is determined by LLM interactive-conversation unit 108. The progression of the states is not strictly sequential and can follow various paths depending on the input or other conditions. States with associated visual content can deliver relevant visual information or demonstrations throughout the conversation.

Action controller unit 110 is an integrated system that encompasses three primary components: action recorder unit 112, action player unit 114, and video recorder/player unit 116. Video recorder/player unit 116 records brief video snippets during the initialization of the virtual AI representative instance. These recorded snippets serve as a reservoir of content, ready for playback during presentations. Their deployment is contingent upon the presentation's context and state of the conversation passed by controller unit 100. Action recorder unit 112 meticulously records all events, including mouse clicks and keyboard strokes, capturing their precise timing when defining the virtual AI representative. Additionally, it embeds “merge tags” within these recordings. Such tags allow for real-time adaptability. For example, if a user originally searched for the weather in Vancouver, the embedded merge tag for “Vancouver” can be seamlessly replaced with another city during a later conversation. Action player unit 114 can mold screen activities during an interactive presentation based on the conversation's context, especially when the virtual AI representative is introducing a new product using the merge tags and the pre-recorded videos. In live presentations, action player unit 114 performs two critical roles. Firstly, it ensures that the timing of the playback mirrors the initial recording. Secondly, it actively monitors browser network activities, making real-time adjustments to the event timings. As an example, if a webpage originally took 2 seconds based on the data provided by action recorder unit 114 but requires 5 seconds during a live presentation, action player unit 114 recalibrates the timing of subsequent events.

Vocalizer unit 118 is an audio processing system, seamlessly integrating three specialized sub-units to deliver optimized voice outputs including audio generator unit 120, audio caching unit 122, audio player unit 124. Audio generator unit 120 generates voice snippets for individual sentences. While several available deep learning models can be employed for this purpose, fine-tuning of the model is required to ensure the fastest response in voice generation. Fine-tuning is done by providing the LLM by some sample conversation scenarios. Audio caching unit 122 serves as a repository, diligently maintaining a database of each vocalized sentence. The primary advantage of this cache is swift access when possible. By storing pre-vocalized sentences, the system dramatically reduces the time required to generate voice snippets for frequently used words or phrases, enhancing overall efficiency and speed. Audio player unit 124 is responsible for the actual playback of the voice snippets. The choice of both the voice format and the playback technology is rooted in their reliability and efficiency. However, the modular nature of vocalizer unit 124 ensures flexibility. If the need arises, alternative technologies and libraries can be integrated to replace the current voice format and playback mechanism.

Knowledge base unit 126 is a system designed to consolidate, process, and provide information tailored to both the product being presented and the user engaged in the conversation. The main objective of knowledge base unit 126 is to provide personalization and context for a purposeful conversation. This unit amalgamates three pivotal components: knowledge base encoder unit 128, LLM interactor-user profiler unit 130, and knowledge base 132. Knowledge base 132 acts as a contextual hub. As discussions around the product evolve, knowledge base 132 dynamically provides relevant product-specific information and user-specific recommendations, ensuring that the conversation remains both informed and engaging.

Knowledge base encoder unit 128 is adept at transforming raw documents into structured, searchable formats. Knowledge base encoder unit 128 employs advanced vectorization techniques to convert documents into a format conducive to rapid searches and retrievals. Subsequent to vectorization, knowledge base encoder unit 128 establishes a database. This reservoir is primed with rich information about the product under discussion, ensuring that the AI virtual representative is equipped with comprehensive product knowledge.

LLM interactor-user profiler unit 130 gathers insights about the user throughout the presentation's duration, as interactions with the user progress, LLM interactor-user profiler unit 130 assiduously records and updates the background information acquired about the user. This includes preferences, past interactions, queries, feedback, and other pertinent details. This reservoir of insights not only ensures that every engagement with the user is rooted in historical context but also paves the way for more personalized and intuitive future interactions. Beyond cataloging user details, LLM interactor-user profiler unit 130 also holds the responsibility of strategizing and noting down future actions post the user interaction. For instance, if a discussion culminates in the decision to share a contract with the user, this action is duly noted and passed to controller unit 100, which eventually will be passed to LLM interactor-user conversation unit 108. Similarly, commitments made during the conversation, like sharing case studies or further information, are systematically recorded. This proactive approach ensures that every commitment made during an interaction is passed to controller unit 100 for required actions after meetings.

User conversation encoder unit 134 acts as a reservoir that encodes users' questions and inputs into vectors across all meetings with different participants for a specific instance of virtual AI representative and then uses this reservoir to find similar question and answer sets. Controller unit 100 polls user conversation encoder unit 134 every time a new user message is received. If user conversation encoder unit 134 finds an existing suitable answer to the user message from before, controller unit 100 uses the existing message as a response to the user and skips sending the message to LLM interactor-user conversation unit 108. The main objective of the unit is to improve response time.

Interrupt and user monitoring unit 136 monitors user presence and interrupts to inform controller unit 100 if there is a need to change the state of the conversation.

This unit maintains two event queues: “user_activity_event_queue” and “controller_event_queue.” “user_activity_event_queue” is used by controller unit 100 to inform the Interrupt and user monitoring unit 136 about other interactions using the following events: “final_state_timeout_triggered,” “long_inactivity_timeout_triggered,” “user_inactivity_timeout_triggered,” and “user_response_playback_triggered.”

Controller unit 100 uses “user_inactivity_timeout_triggered” message to start a process of checking on the user every 20 seconds and uses “long_inactivity_timeout_triggered” message to end the conversation after 5 minutes if there is no answer. When in the final state, controller unit 100 uses “final_state_timeout_triggered” message to end the conversation after a period of inactivity from the user to ensure the conversation has ended gracefully. Controller unit 100 uses “user_response_playback_triggered” message to inform interrupt and user monitoring unit 136 that the user is done talking and now we are waiting on the AI response from LLM interactor-user conversation unit 108.

Application Programming Interface (API) Server Unit 140, as embodied in the present invention, serves as an interface for the virtual AI representative, designed to handle synchronous communication events and audio data transmissions. The primary objective of this unit is to efficiently manage a series of events, such as participants joining or leaving a virtual meeting platform (meeting application unit 136), or any status changes within the meeting through its ‘/webhook’ endpoint. Depending on the nature of the event received, API server unit 140 triggers an appropriate function, placing the event details into an event queue for subsequent handling by controller unit 100. Another salient feature of API server unit 140 is its capability to handle raw audio data from virtual meetings. Through the ‘/meeting-raw-audio’ API endpoint, the unit accepts raw binary audio data and subsequently queues it into an “audio_output_queue” for controller unit 100 to pass it to transcriber unit 118. In sum, API server unit 140 in the present invention, effectively bridges the virtual Al representative with external systems, while ensuring seamless event and audio data management.

Meeting application unit 142 used in the virtual AI representative is to provide a bidirectional communication channel between the virtual AI representative and a potential participant. The modular design of the virtual AI representative makes it possible for any meeting application to be used as a component as long as it has the capability of passing the raw audio and autonomous screen share. For the present innovation, Zoom SDK is used as the meeting application.

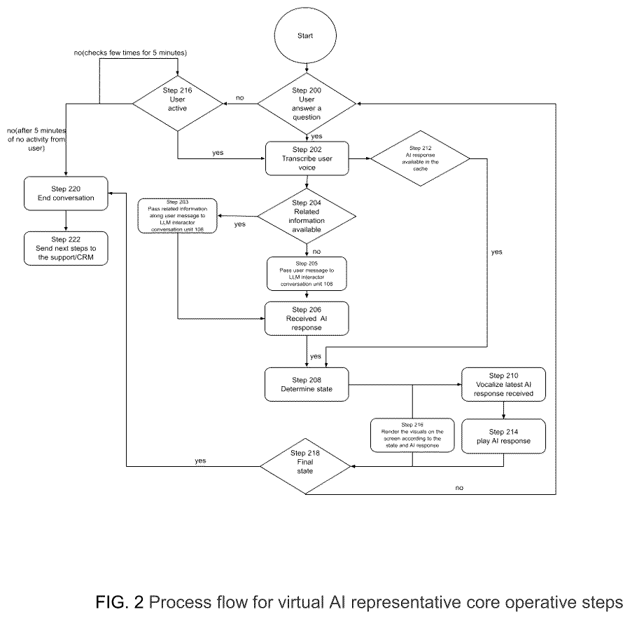

Data flow within the virtual AI representative core is depicted in FIG. 2. At the start of each conversation cycle, the conversation cycle consists of a back and forth between the participant and the virtual AI representative, upon reception of user's verbal communication (step 200), user input unit 102 commences speech-to-text conversion (step 202), resulting in one or more transcribed interim messages. Each transcribed interim message is tagged with a unique integer identifier before being forwarded to controller unit 100. In step 212 of FIG. 2, controller unit 100 sends an inquiry to user conversation encoder unit 134 to check if there is any available Al response in the cache before making an inquiry. Controller unit 100 sends an inquiry to knowledge base unit 126 to find relevant information based on the user's message (step 204); if the poll results in any related information or answer, controller unit 100 creates a system message based on the poll. Controller unit 100 sends user messages alongside the system message to LLM interactive-conversation unit 108.

Upon receipt of LLM interactive-conversation unit 108 response (Al response) in step 206, the state of the conversation is determined and controller unit 100 prompts audio generator unit 120 to synthesize an audio file corresponding to the AI response (step 210). Once the audio file is generated, it is sent back to controller unit 100, and then forwarded to vocalizer unit 118, setting it in standby mode.

If a new interim message from the participant is detected during this process, the existing audio file is discarded. The system reverts to the interim message handling stage, and the cycle repeats to generate a new response for the virtual sales agent.

When user input unit 102 receives the participant's final spoken message, controller unit 100 checks its similarity against the last interim message. If they are similar, controller unit 100 prompts vocalizer unit 118 to play the already generated audio. Otherwise, the system returns to the interim message handling stage (step 200) to generate a new AI response corresponding to the user's final message. This new response is then vocalized and played.

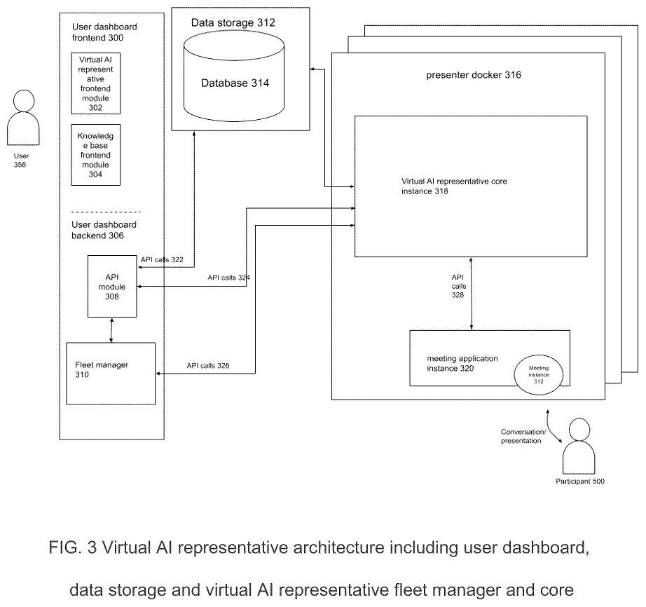

FIG. 3 draws an overview of the platform software architecture. User dashboard frontend 300 is a stand-alone application that provides user 358 with access to create or manage virtual AI representative instances to present a product. User dashboard backend 306 includes API module 308 to communicate with database 314, virtual AI representative instances, and fleet manager 310.

In FIG. 3, presenter docker 316 is created using a serverless compute engine (such as AWS Fargate or similar services). User dashboard backend 306 oversees the containers, handling tasks such as creation, stopping, and status querying using fleet manager 310. Subsequently, fleet manager 310 invokes presenter docker 316. A new presenter container is initialized for every meeting session (i.e. presenter docker 316 is a dedicated container for only one meeting). Presenter docker 316 comprises two components: Virtual AI representative core instance 318 and meeting application 320.

Upon the initiation of a presenter docker container, two main instances are activated to start and manage the meeting. The first is virtual AI representative core instance 318, which is responsible for overseeing meeting application instance 320 and ensuring seamless communication with the user dashboard backend 306. Its role is pivotal; if this process were to exit, the container would stop functioning, indicating its significance in the architecture.

Meeting application instance 320 is launched in conjunction with virtual Al representative core instance 318. This secondary instance is governed by virtual Al representative core instance 318 and operates under the directives of a representational state transfer (REST) API specific to the meeting application. Its primary function is to start a meeting session that allows for the display of presentations through window sharing. Moreover, it supports bidirectional audio streams, facilitating interactive communication channels during meetings.

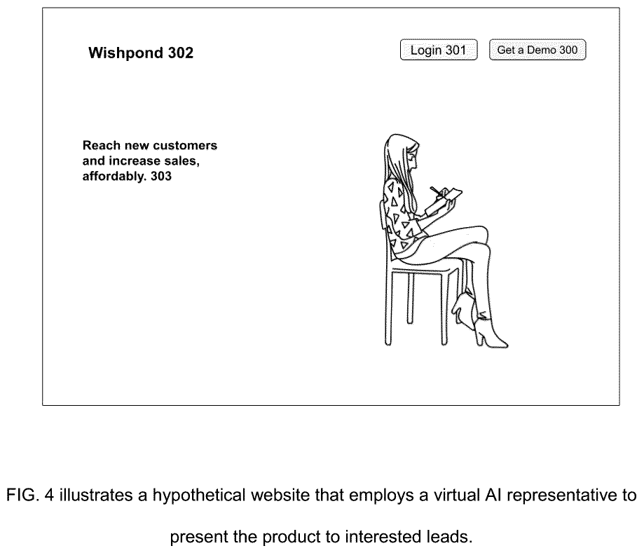

FIG. 4 illustrates an exemplary website that employs a virtual Al representative to present the product to interested leads. Upon clicking on Get a Demo 300 button, participant 500 is asked for his/her email address and the meeting link is sent to the email address. By clicking on the Uniform Resource Locator (URL) or the colloquially known as an address on the Web, the meeting starts and the virtual Al representative starts the presentation.

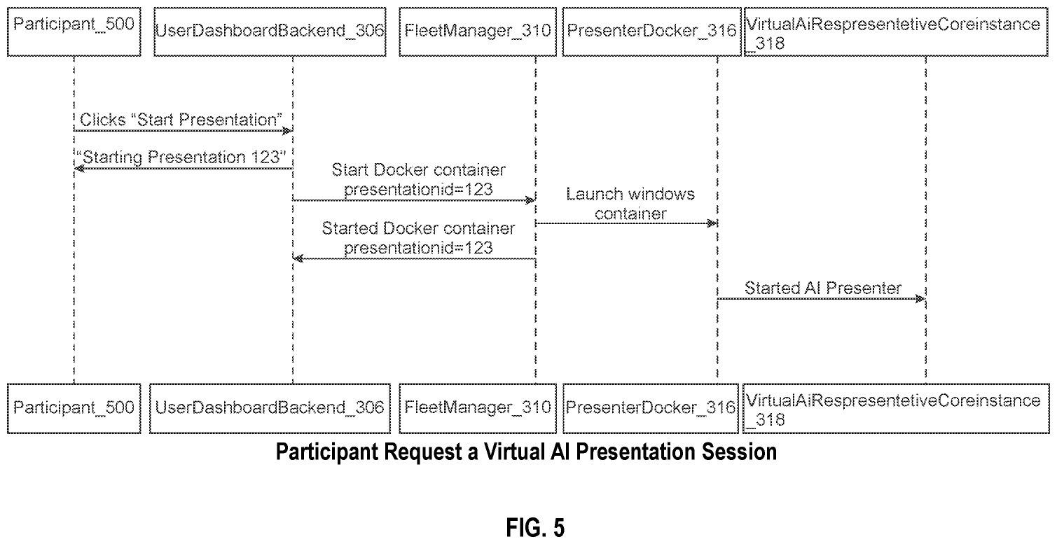

FIG. 5 illustrates in detail the chain of events when a participant requests a meeting/presentation. To start a presentation, fleet manager 310 starts presenter docker 316 and injects environment variables. The environment variables are: “meeting id” and API credentials. Meeting id identifies a specific instance of a virtual Al representative (e.g. the same participant might have multiple meetings scheduled). API credentials are used by virtual AI representative core instance 318 to call into API module 145.

Virtual AI representative instance 318 makes API calls to user dashboard backend 306 to fetch the blueprint of states, lead information (participant name to use in the meeting etc.), and knowledge base information.

Virtual AI representative core instance 318 kicks off the process by first stopping all existing meeting application instance 320 processes within presenter docker 316, and then starting meeting application instance 320 via the command line. Meeting application instance 320 sends a meeting URL to virtual AI representative core instance 318 via webhooks to http://localhost: 4000. Virtual AI representative core instance 318 sends the meeting URL to user dashboard backend 308 using REST API POST. When meeting application instance 320 starts, virtual AI representative core instance 318 controls it using a REST API located at localhost: 3000 with “start_meeting,” “stop_meeting,” “play_audio,” and “share_window” end points.

Webhooks sent by meeting application instance 320 to virtual Al representative core instance 318 includes “meeting_started,” “meeting_stopped,” “meeting_failed,” “meeting_connecting,” “meeting_disconnecting,” “user_joined,” “user_left,” “sharing_status_changed.”

Meeting application instance 320 sends raw audio from the participant to virtual AI representative core instance 318.

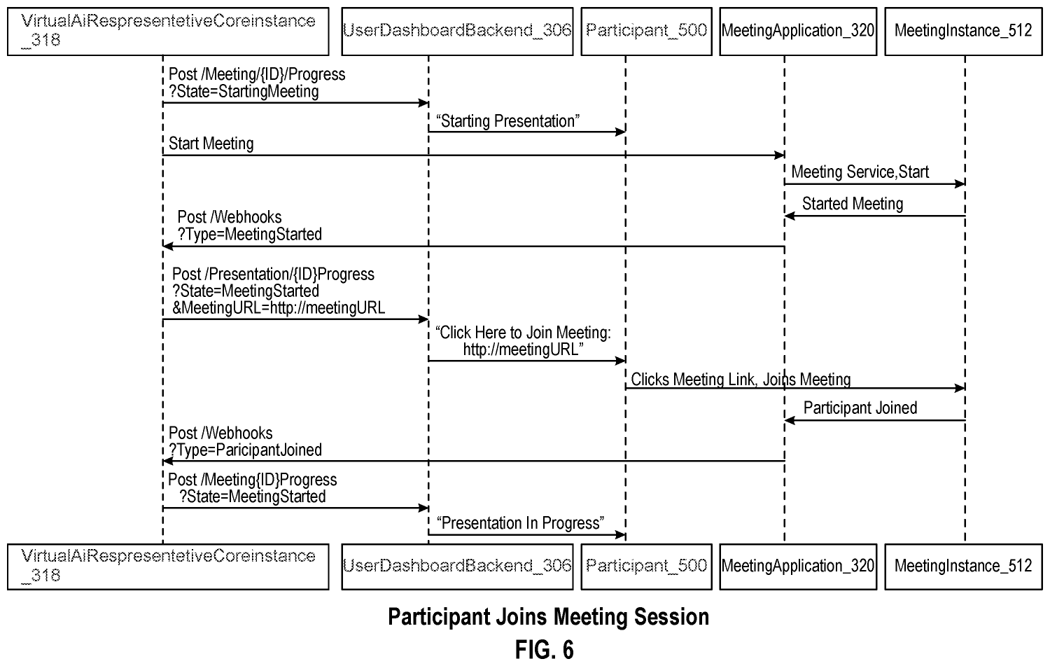

To launch a meeting, virtual AI representative core instance 316 fetches information about the meeting from dashboard backend 306, then runs a worker job to start the meeting (FIG. 6). Upon receiving the meeting URL from virtual Al representative core instance 318, user dashboard backend 306 sends the meeting URL to participant 500. If user dashboard backend 306 does not receive the meeting URL after a period of time, it can decide to terminate presented docker 316 and start the container again if desired.

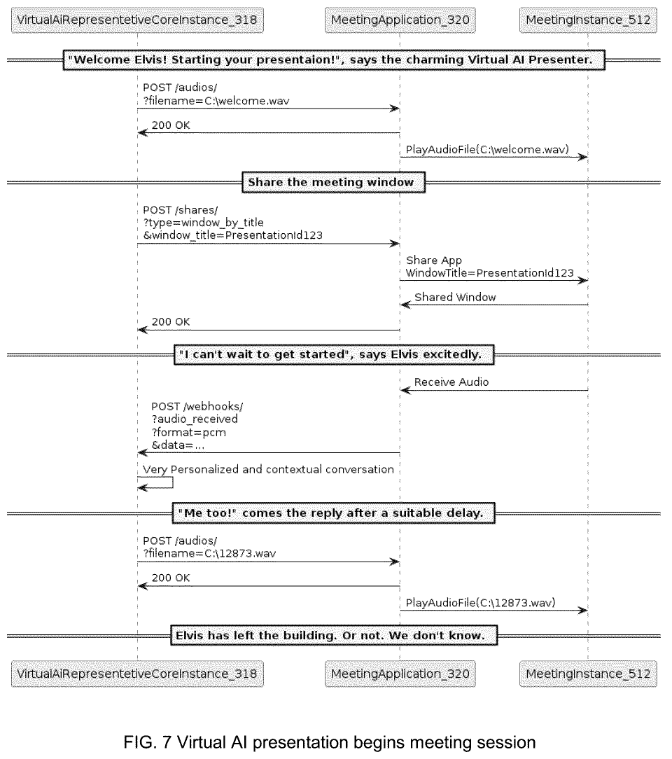

In FIG. 7, virtual AI representative core instance 318 starts the meeting with an API call to meeting application instance 320 and sends the welcome voice snippet. Meeting application instance 320 confirms receiving the voice snippet and relays it to meeting instance 512. Then virtual AI representative core instance 318 initiates screen share and waits for the response from meeting instance 512. Upon receiving the response, virtual AI representative core instance 318 follows the steps in FIG. 2 and continues the conversation.

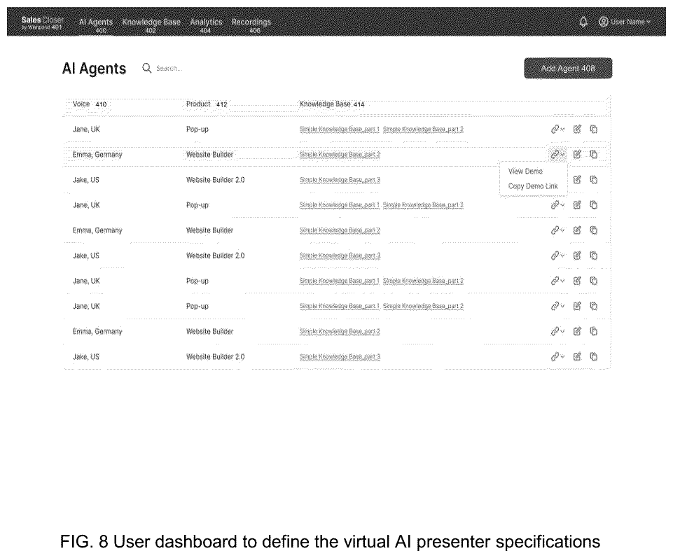

FIG. 8 illustrates user dashboard frontend 141. User 358 uses the software tool available on user dashboard frontend 141 to create and manage virtual Al representatives and the flow of the conversation via defining states for state manger unit 102.

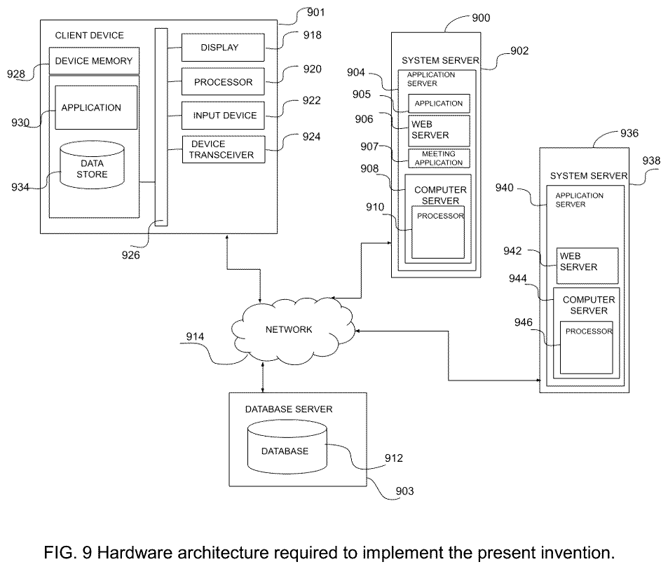

FIG. 9 illustrates the hardware architecture of the present invention. The present invention's platform architecture is outlined as follows: Users engage with system server 900 via client device 901. Client device 901 connects to server 902 through network 914 and can operate on any chosen computing platform. Server 902 interfaces with client devices over this network to provide a user or graphical interface (GUI) for system 900. This interface, accessible via web browsers or specific software applications, facilitates data display, entry, publication, and management, acting as a meeting interface. The term “network” here refers to a network collection appearing as one to users, including the Internet, which connects using Internet Protocol (IP) and similar protocols. The public network 914 depicted in FIG. 9 serves only as an example.

Server 902 may offer services relying on a database system accessible over a network and via server 936. The GUI or meeting interface, provided by server 902 on client device 901 via a web browser or app, allows for operation and utilization of service system 900. The components in system server 902 and 936 represent a combination necessary for providing the services and tools envisioned by the invention. These components, which may communicate over a WAN or LAN, include an application server or executing unit 904 comprising a web server 906 and a computer server 908. The web server responds to HTTP requests from remote browsers or software applications, providing the necessary user interface. The computer server may include a processor, RAM, and ROM, controlled by operating system software for resource allocation and task management.

The database tier, with at least one database server 903, interfaces with multiple databases 912, updated via private networks including the Internet. Although described as a single database, separate databases can store various user data and files.

Application server 940, custom-built for this invention, enables various tasks related to creating and customizing the virtual AI representative sits on an exemplary system server 938. “User dashboard” henceforth refers to the web browser interfaces for accessing application server 940 of this invention. Application server 940 communicates with application 905 via API calls through network 914. “Virtual Al representatives instance” henceforth refers to application 905. Users interact with meeting application 907 via web server 906. “Meeting instance” henceforth refers to the web interface of meeting application 907.

Client devices 901 may include a range of electronic devices with various components. For instance, client device 901 may feature a display, processor, input device, transceiver, memory, app, local data store, and a data bus interconnecting these components. The term “transceiver” encompasses any known transmitter or receiver for communication. These components may vary, and alternative embodiments are considered within the invention's scope.

In an embodiment, communication begins when an audio message is sent by either the virtual representative or the user, triggering the communication. This audio is then translated into written text, each instance of which is assigned a distinct numerical identifier before being forwarded to controller unit 100. Controller unit 100, in turn, instructs user conversation encoder unit 134 to search knowledge base unit 126 for pertinent information. Utilizing this information, the system crafts messages from both the system's and the user's perspectives and directs them to LLM interactive-conversation unit 108. LLM interactive-user conversation unit 108 then produces a text-based reply, which is subsequently synthesized into an audio message for the user's consumption in vocalizer unit 118. Should there be an interruption with a new message from the user while this process is underway, the audio response is modified to reflect this latest communication. Only an audio file that is confirmed to be current and representative of the user's most recent message is played. With each round of dialogue, the unique numerical tag is advanced, readying the system for the next round of interaction.

In an embodiment, at each step controller unit 100 uses LLM interactive-user conversation unit 108 and state manager unit 102 to infer the state and parameters of the conversation that are passed to action controller unit 110 to create the suitable action to be presented on the screen alongside the vocalized response from LLM interactive-conversation unit 108. Synchronizing the visual part of the interactive presentation with the conversation is a challenge that this embodiment addresses via interaction between controller unit 100, action controller unit 126, and state manager unit 102.

The embodiment further includes the various states of the conversation comprising preparation, hold, wait, abandon, or finalized. There may be further states as well and this is flexible and may be provided to controller unit 100. For each different product that the AI virtual representative presents, the number of states can be adjusted accordingly.

Fine-tuning LLM interactive-conversation unit 108 for interactive conversation is essential because standard NLP models may not be optimized for real-time, interactive dialogues, and they might produce responses that are not contextually accurate or coherent. Leveraging an LLM interactor as a knowledge base for context, combined with another LLM interactor for user profiling that provides related information as personalized context, can help fine-tune pre-trained language models on domain-specific data, thereby significantly enhancing performance and yielding more contextually accurate and coherent responses.

Synchronizing conversation flow and interactive presentation is an essential aspect in creating a seamless transition especially when the presentation is conditional on the dialogue flow. To solve this problem, in the present invention, event-driven architecture is implemented in controller unit 100 to trigger specific presentation steps based on a blueprint provided to state manager unit 102 at the time of the creation of the AI virtual representative code 154. State manager unit 102 is a robust dialogue management system used by controller unit 100 alongside the LLM interactor-user conversation unit 108 that is capable of adaptively controlling the flow of the conversation. To create synchronization between the audio and video controller unit 100 infers the step and parameters of the conversation from the response of LLM interactor-conversation unit 108 and sends it to action controller unit 110 to be played alongside the vocalized response of LLM interactor-user conversation unit 108.

Harmonizing asynchronous threads is a complex task, especially when multiple threads are running to monitor various aspects of the conversation, including user engagement, sentiment, or intent. However, in the present invention, the use of message queues, shared state-management systems, flags, and events within the threads can be instrumental in synchronizing these various asynchronous tasks, ensuring a more coherent interaction.

Maintaining a natural conversation flow and minimizing response delay are crucial for user experience. To ensure a conversation feels natural, the system must generate responses within a fraction of a second, a challenge due to both the computational complexity of LLMs and the network response rate. One solution is to implement a stateful conversation model that remembers past interactions and context, helping preserve a seamless flow. When users pose a new inquiry, controller unit 100 polls user conversation encoder unit 134 to identify useful AI responses from the past. If a match is found, controller unit 100 quickly prompts vocalizer unit 122 to ensure a swift and relevant reply.

Systems such as traditional sales models that rely heavily on human agents to manage customer queries, presentations, and follow-ups often face scalability challenges. In contrast, the virtual AI representative can manage multiple interactions at once and offers easy scalability. This capability enables businesses to cater to an expanding customer base without the need to proportionally increase their workforce.

Systems that rely heavily on human resources, such as those with a large sales team, can become expensive due to salaries, benefits, and training costs. In contrast, the virtual AI representative described in this invention offers a more cost-effective solution over time. The virtual AI representative not only eliminates the need for a sizable team but also ensures continuous 24/7 service.

Human representatives might sometimes lack immediate access to comprehensive customer data, hindering their ability to offer a truly personalized experience. In contrast, the AI virtual representative has the capability to swiftly analyze user's data, enabling it to provide highly personalized recommendations and solutions. This not only enhances user engagement but also potentially boosts conversion rates.

Human representatives can occasionally experience off days, and their level of expertise might differ from one individual to another, which can result in varying presentation experiences. On the other hand, the virtual AI representative is designed to provide a consistent level of service, guaranteeing that each interaction aligns with the desired quality standards.

Unlike human representatives who aren't available 24/7, potentially posing challenges for businesses that operate across various time zones or for users who seek interactions beyond standard business hours, the virtual AI representatives have the advantage of being available continuously. This ensures constant support and engagement for users at any given time.

While human representatives typically manage just one interaction at a time and might exhibit slower response times during peak hours or while multitasking, the virtual AI representatives excel in offering prompt feedback. This capability ensures that users receive answers or information with minimal delay, enhancing the overall user experience.

Decision-making during a course of a real-time interaction often hinges on intuition and experience rather than concrete data when done by human representatives. However, the virtual AI representative is equipped to amass and scrutinize extensive data, furnishing invaluable insights into user behaviors and predilections. Such insights can be pivotal for shaping future strategies and making informed decisions. This advantage is not just limited to sales; various other domains can also benefit from employing virtual AI representatives to harness data-driven insights.

When businesses or organizations venture into global markets, they often encounter language barriers, especially if they lack employees proficient in the target market's language at various locations. In contrast, virtual AI representatives can be endowed with capabilities to understand and communicate in multiple languages. This adaptability facilitates seamless engagement with a diverse and global user base.

By addressing these challenges, the present invention provides a virtual Al representative offers a transformative solution for businesses and organizations, enabling them to improve customer engagement, drive sales, and operate more efficiently, improve customer care, and serve better.

What is claimed is:

1-14. (canceled)

15. A computer program product for facilitating a directed conversation according to a criteria between an artificially-intelligent (AI) agent and an audience having program instructions embodied therewith, the program instructions executable on a processing circuit to cause the processing circuit to perform the steps comprising:
receiving by an AI system including the AI agent, a state machine controlling the directed conversation;
ingesting a knowledge base for the directed conversation by the AI system; and
provide an interactive presentation for the directed conversation, by the AI agent, as indicated by the state machine.

16. The computer program product of claim 15, wherein each entry in the received state machine further comprises:
a name, an instruction to perform by the AI agent, a transition condition, a next state, and an action for the AI agent to take after performing the instruction.

17. The computer program product of claim 15, wherein the criteria is defined by the received state machine.

18. The computer program product of claim 15, wherein the directed conversation is emulating a virtual sales agent.

19. The computer program product of claim 15, wherein the directed conversation is emulating a virtual customer service representative.

20. The computer program product of claim 15, wherein the directed conversation is emulating a virtual healthcare provider.

21. The computer program product of claim 15, further comprising:
incorporating a set of predefined built-in system states in the state machine and wherein the set of predefined built-in system states include audio connection, a first state, a hold state, an interrupt state, and a tangent state.

22. The computer program product of claim 15, wherein the directed conversation is emulating a virtual healthcare provider.

23. The computer program product of claim 15, wherein the directed conversation is emulating a virtual instructor.

24. The computer program product of claim 15, wherein the directed conversation is emulating a virtual advisory service provider.

25. The computer program product of claim 15, wherein the directed conversation is emulating a virtual recruiter.
